(19) United States
(12) Patent Application Publication
(10) Pub. No.: US 2005/0175859 A1
(43) Pub. Date: Aug. 11, 2005

(54) Organic electroluminescent material and organic electroluminescent device by using the same

(75) Inventor: Hsien-Chang Lin, Jubei City (TW)

Correspondence Address: BIRCH STEWART KOLASCH & BIRCH, PO BOX 747, FALLS CHURCH, VA, 22040-0747, US

(73) Assignee: RITDISPLAY CORPORATION

(21) Appl. No.: 11/024,771

(22) Filed: Dec. 30, 2004

(30) Foreign Application Priority Data
Dec. 31, 2003 (TW) 092137853

(51) Int. Cl. H05B 33/14

(52) U.S. Cl. 428/690; 428/917; 313/504; 313/506; 257/102; 257/103

(57) ABSTRACT

An organic electroluminescent material is for using in a light-emitting layer or a hole-transporting light-emitting layer of an organic electroluminescent device. The organic electroluminescent material is of the formula (1): 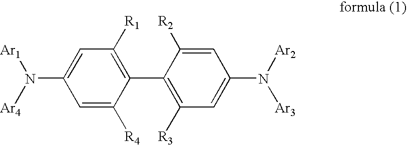
wherein R₁, R₂, R₃, R₄ are one selected from the group consisting of hydrogen atom, substituted or unsubstituted alkyl group having 1 to 6 carbon atoms and substituted or unsubstituted aryl group having 6 to 40 carbon atoms, Ar₁, Ar₂, Ar₃, Ar₄ are a substituted or unsubstituted aryl group having 6 to 40 carbon atoms.

### BACKGROUND OF THE INVENTION

1. Field of Invention

The invention relates to an electroluminescent material and an electroluminescent device and, in particular, to an organic electroluminescent material and an organic electroluminescent device.

2. Related Art

Following the advances in electronic technology, light weight and high efficiency displays, such as liquid crystal displays (LCD), are well developed. However, the LCD has several drawbacks: the narrow viewing angle, the response time which is not fast enough to display high-speed animation, and the increased power requirement for driving the panel.

Compared with the LCD, organic light-emitting display (OLED) is self-emissive and has the excellent properties of wide viewing angle, high power efficiency, easily to be manufactured, low cost, fast response speed and full color. Therefore, organic light-emitting display could potentially be the major flat panel display and light source, including being used as special light sources and for normal illumination, in the future. On the other hand, the organic light-emitting display is also classified into two types, i.e. the active matrix OLED (AM-OLED) and the passive matrix OLED (PM-OLED) according to the driving method.

The OLED includes a substrate, a first electrode, an organic functional layer and a second electrode. When applying a direct current to the OLED, holes are injected from the first electrode into the organic functional layer while electrons are injected from the second electrode. Based on the applied voltage, the holes and electrons are moved into the organic functional layer, and are recombined to generate excitons then emit light to release energy. The organic functional layer may include a hole-injecting layer, a hole-transporting layer, a light-emitting layer, an electron-transporting layer, an electron-injecting layer and their combination. The color of the emitted light from the light-emitting layer varies according to the energy gap between ground state and excited state of the materials in the light-emitting layer. One of ordinary skill in the art should know that the organic light-emitting display, which is classified into the small molecule OLED (SM-OLED) and the polymer light-emitting display (PLED) according the molecule weights of the organic electroluminescent materials.

As mentioned above, the materials of the organic functional layer have been studied for a long time. In these studies, the fluorescent materials are commonly used in the light-emitting layer. Besides the fluorescent materials, there are many studies, e.g. Applied Physics letters, vol. 74, No. 3, P442-444, 1999, Applied Physics letters, vol. 75, No. 1, P4-6, 1999, U.S. Pat. No. 6,097,147, U.S. Pat. No. 6,303,238 and U.S. Pat. No. 6,310,360, mentioned the phosphorescent materials. Regarding to the studies of organic electroluminescent materials, most of the emitted light is fluorescent light, which is by the singlet state transformed to the ground state. According to the spin multiplicity rule, the singlet state of organic electroluminescent molecules are only 25% of all excited organic electroluminescent molecules comprising the residual 75% of triplet state of organic electroluminescent molecules (phosphorescent types). To be noted, not all of the excited molecules release energy through the light emission, and some deactive energy by the intersystem transition, intersystem crossing (ISC) or decay of intersystem. In the present research, the materials that can emit phosphorescent light via the excited triplet molecules are all organometallic compounds with the center metal atom of transition metals such as osmium (Os), iridium (Ir), platinum (Pt), europium (Eu), ruthenium (Ru) and the likes, and the coordination compound of azo heterocyclic compounds.

Recently, the phosphorescent material, which is used for manufacturing the OLED and serves as the major electroluminescent material of the light-emitting layer, usually comprises 4,4′-N,N′-dicarbazolebiphenyl (CBP) composed of carbazole of the following formulas H-1 and H-2. However, this kind material has poor stability that causes the shortened lifetime of the OLED containing the phosphorescent material. Thus, the application of the phosphorescent materials is reduced.

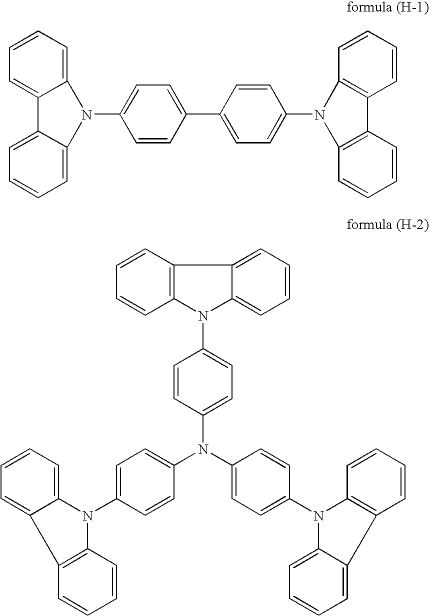

It is therefore an important subjective of the invention to provide an organic electroluminescent material and an organic electroluminescent device, which can overcome the application limitations of the phosphorescent materials applied in OLED.

### SUMMARY OF THE INVENTION

In view of the foregoing, the invention is to provide an organic electroluminescent material with a high stability for overcoming the application limitations of the phosphorescent materials in an organic electroluminescent device and increasing the lifetime of the organic electroluminescent device. Since the organic electroluminescent material of the invention has excellent hole-transporting ability, the light-emitting layer and the hole-transporting layer of the organic electroluminescent device can be well integrated so as to decrease the complexity of the layers, greatly simplify the manufacturing processes of the organic functional layer, and efficiently produce the organic electroluminescent device with high efficiency and longer lifetime.

To achieve the above, an organic electroluminescent material of the invention for using in a light-emitting layer of an organic electroluminescent device and is of the formula (1): 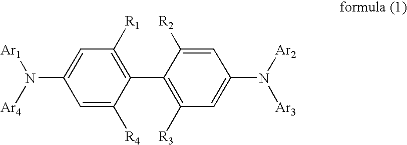
wherein R₁, R₂, R₃, R₄ are one selected from the group consisting of hydrogen atom, substituted or unsubstituted alkyl group having 1 to 6 carbon atoms and substituted or unsubstituted aryl group having 6 to 40 carbon atoms, and Ar₁, Ar₂, Ar₃, Ar₄ are a substituted or unsubstituted aryl group having 6 to 40 carbon atoms.

To achieve the above, an organic electroluminescent material of the invention for using in a hole-transporting light-emitting layer of an organic electroluminescent device and is of the formula (8): 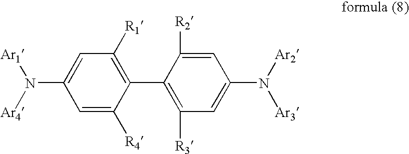
wherein R₁′, R₂′, R₃′, R₄′ are one selected from the group consisting of hydrogen atom, substituted or unsubstituted alkyl group having 1 to 6 carbon atoms and substituted or unsubstituted aryl group having 6 to 40 carbon atoms, and Ar₁′, Ar₂′, Ar₃′, Ar₄′ are a substituted or unsubstituted aryl group having 6 to 40 carbon atoms.

To achieve the above, an organic electroluminescent device of the invention comprises a substrate, a first electrode, a second electrode and a light-emitting layer. The first electrode, the light-emitting layer and the second electrode are disposed over the substrate in sequence. The light-emitting layer comprises a phosphorescent material and an organic electroluminescent material of the formula (15): 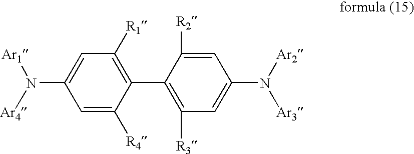
wherein R₁″, R₂″, R₃″, R₄″ are one selected from the group consisting of hydrogen atom, substituted or unsubstituted alkyl group having 1 to 6 carbon atoms and substituted or unsubstituted aryl group having 6 to 40 carbon atoms, and Ar₁″, Ar₂″, Ar₃″, Ar₄″ are a substituted or unsubstituted aryl group having 6 to 40 carbon atoms.

To achieve the above, an organic electroluminescent device of the invention comprises a substrate, a first electrode, a second electrode and a hole-transporting light-emitting layer. The first electrode, the hole-transporting light-emitting layer and the second electrode are disposed over the substrate in sequence. The hole-transporting light-emitting layer comprises a phosphorescent material and an organic electroluminescent material of the formula (22): 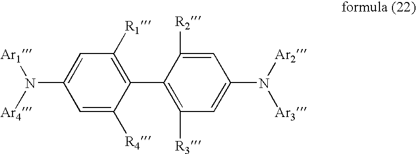
wherein R₁′″, R₂′″, R₃′″, R₄′″ are one selected from the group consisting of hydrogen atom, substituted or unsubstituted alkyl group having 1 to 6 carbon atoms and substituted or unsubstituted aryl group having 6 to 40 carbon atoms, and Ar₁′″, Ar₂′″, Ar₃′″, Ar₄′″ are a substituted or unsubstituted aryl group having 6 to 40 carbon atoms.

As mentioned above, the organic electroluminescent material and device comprise the compound containing triarylamine group and excluding carbazole derivative compounds. Compared with the prior art, the organic electroluminescent material of this invention has a higher stability so as to prolong the lifetime of the organic electroluminescent device. In addition, the light-emitting layer and hole-transporting layer can be integrated since the organic electroluminescent material has excellent hole-transporting ability. Accordingly, the complexity of the layers of the device can be decreased, the manufacturing processes of the organic functional layer can be greatly simplified, and the organic electroluminescent device with a high efficiency and longer lifetime can be efficiently produced.

### BRIEF DESCRIPTION OF THE DRAWINGS

The invention will become more fully understood from the detailed description given herein below illustration only, and thus is not limitative of the present invention, and wherein:

FIG. 1 is a schematic view showing an organic electroluminescent device according a first embodiment of the invention;

FIG. 2 is a spectrum schematic diagram having a vertical axis of intensity and a horizontal axis of wavelength; and

FIG. 3 is a schematic diagram having a vertical axis of lifetime and a horizontal axis of time.

### DETAILED DESCRIPTION OF THE INVENTION

The present invention will be apparent from the following detailed description, which proceeds with reference to the accompanying drawings, wherein the same references relate to the same elements.

### First Embodiment

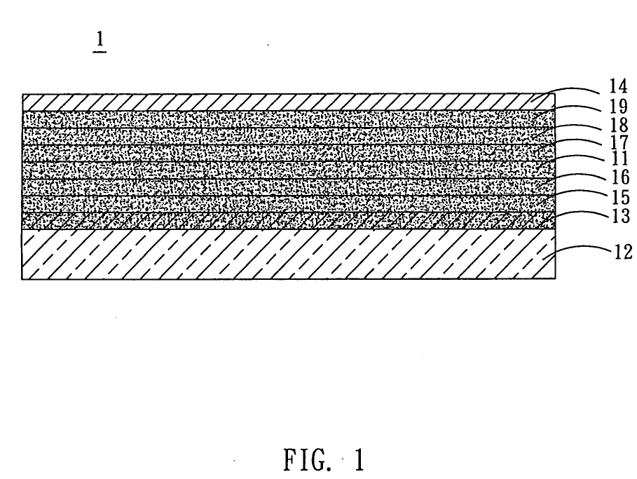

As shown in FIG. 1, an organic electroluminescent material according to the first embodiment of the invention is used for a light-emitting layer 11 of an organic electroluminescent device 1. The organic electroluminescent material is made of the formula (1): 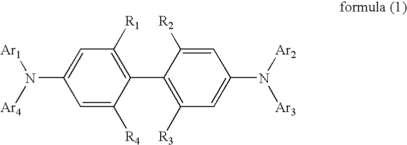
wherein R₁, R₂, R₃, R₄ are one selected from the group consisting of hydrogen atom, substituted or unsubstituted alkyl group having 1 to 6 carbon atoms and substituted or unsubstituted aryl group having 6 to 40 carbon atoms, and Ar₁, Ar₂, Ar₃, Ar₄ are a substituted or unsubstituted aryl group having 6 to 40 carbon atoms.

Regarding to R₁, R₂, R₃, R₄ of the organic electroluminescent material of the formula (1), the substituted alkyl group having 1 to 6 carbon atoms is selected from the group consisting of substituted methyl, substituted ethyl, substituted propyl, substituted isopropyl, substituted butyl, substituted isobutyl, substituted 2-butyl, substituted 3-butyl, substituted linear chain pentyl, substituted branched pentyl, substituted linear chain hexyl and substituted side chain hexyl, and the unsubstituted alkyl group having 1 to 6 carbon atoms is selected from the group consisting of methyl, ethyl, propyl, isopropyl, butyl, isobutyl, 2-butyl, 3-butyl, linear chain pentyl, branched pentyl, linear chain hexyl and side chain hexyl. Regarding to Ar₁, Ar₂, Ar₃, Ar₄ of the organic electroluminescent material of the formula (1), the substituted aryl group having 6 to 40 carbon atoms is selected from the group consisting of substituted phenyl, substituted naphthyl, substituted anthracyl, substituted phenanthryl, substituted pyryl, substituted biphenylyl, substituted triphenylyl, substituted triphenylamine, substituted furan, substituted thiophene and substituted indole, and the unsubstituted aryl group having 6 to 40 carbon atoms is selected from the group consisting of phenyl, naphthyl, anthracyl, phenanthryl, pyryl, biphenylyl, triphenylyl, triphenylamine, furan, thiophene and indole.

As mentioned above, the substituent group of the substituted aryl group having 6 to 40 carbon atoms is selected from the group consisting of alkyl group having 1 to 6 carbon atoms (such as, for example but is not limited to, one of methyl, ethyl, propyl, isopropyl, butyl, isobutyl, 2-butyl, 3-butyl, linear chain pentyl, branched pentyl, linear chain hexyl and branched hexyl), cycloalkyl group having 3 to 6 carbon atoms (such as, for example but is not limited to, one of cyclopropyl, cyclobutyl, cyclopentyl and cyclohexyl), alkoxyl group having 1 to 6 carbon atoms (such as, for example but is not limited to, one of methoxyl, ethoxyl, propoxyl, isopropoxyl, butoxyl, isobutoxyl, 2-butoxyl, 3-butoxyl, linear chain pentyloxyl, branched pentyloxyl, linear chain hexoxyl and branched hexoxyl), aryloxy having 5 to 18 carbon atoms (such as, for example but is not limited to, one of phenyloxy, tolyloxy and naphthyloxy), aralkoxy having 7 to 18 carbon atoms (such as, for example but is not limited to, one of phenethyloxy and naphthoxyl), amino substituted with aryl group having 5 to 16 carbon atoms (such as, for example but is not limited to, one of dianilino, xylidino and naththyl aniline), nitro group, cyano group, ester group having 1 to 6 carbon atoms and halogen. For instance, the organic electroluminescent material of this embodiment can be but not limited to one compound of the following formulas (H-3) to (H-16):

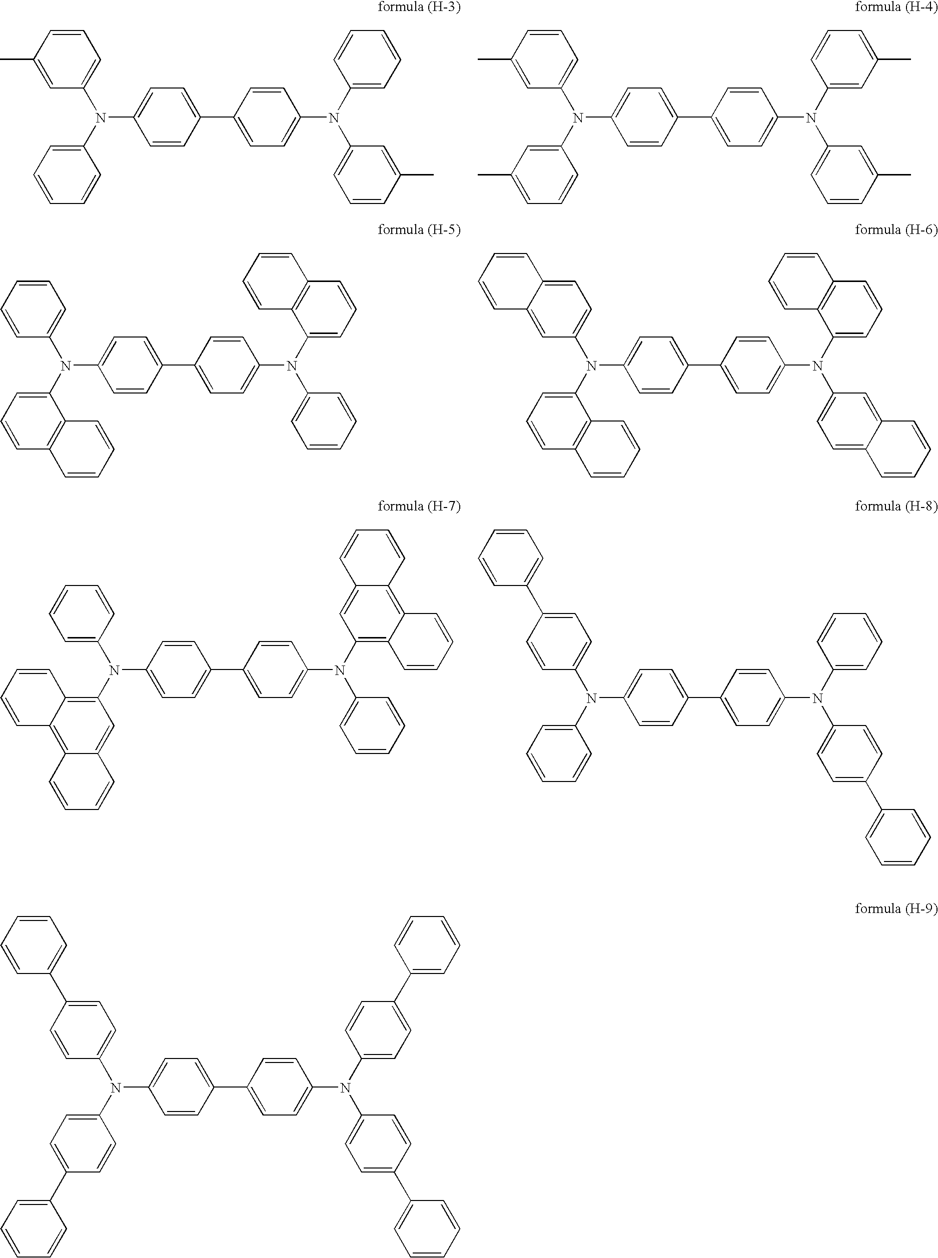

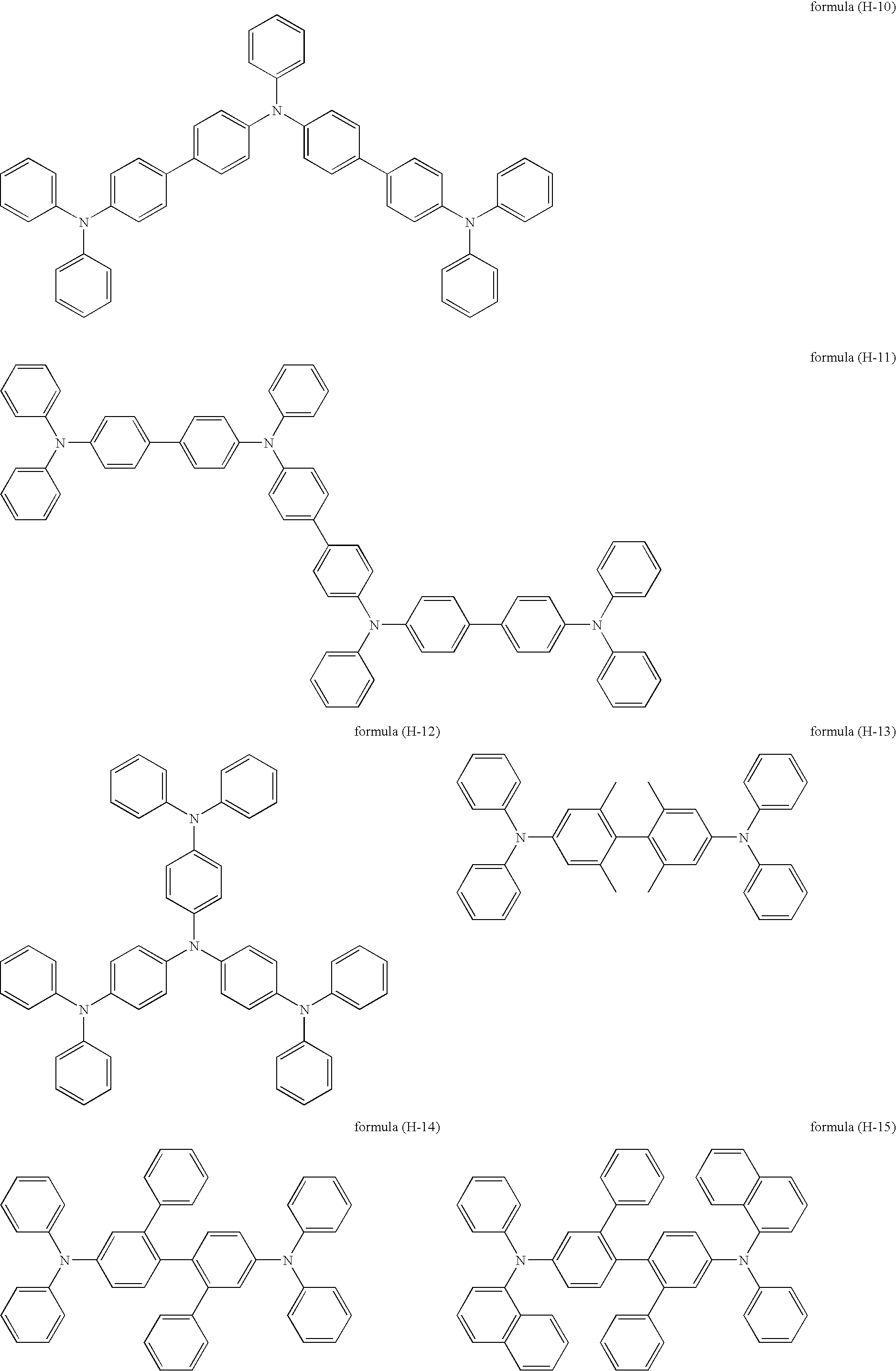

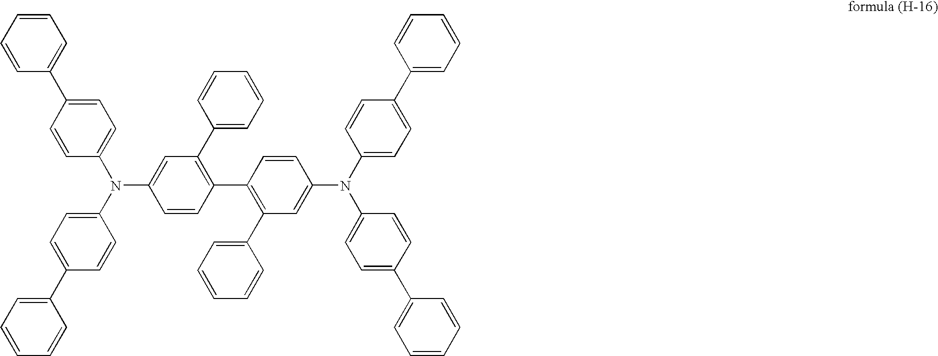

In addition, as shown in FIG. 1, the organic electroluminescent device 1 comprises a substrate 12, a first electrode 13, the light-emitting layer 11 and a second electrode 14. The first electrode 13, light-emitting layer 11 and second electrode 14 are disposed over the substrate 12 in sequence.

In the present embodiment, the substrate 12 can be a flexible or a rigid substrate. The substrate 12 can also be a plastic or glass substrate. In particular, the flexible substrate or plastic substrate comprises polycarbonate (PC), polyester (PET), cyclic olefin copolymer (COC) and metallocene-based cyclic olefin copolymer (mCOC). In addition, the substrate 12 can be a silicon substrate.

The first electrode 13 is formed on the substrate 12 by a sputtering method or an ion plating method. The first electrode 13 is usually used as an anode and made of a transparent conductive metal oxide, such as indium-tin oxide (ITO), aluminum-zinc oxide (AZO), indium-zinc oxide (IZO) or cadmium-tin oxide (CdSnO).

The light-emitting layer 11 may be formed upon the first electrode 13 by utilizing evaporation, spin coating, ink-jet printing or printing. Herein, the light emitted from the light-emitting layer 11 is blue, green, red, white, other monochromic lights or colorful light. In the current embodiment, the light-emitting layer 11 emits phosphorescent light.

The light-emitting layer 11 may further comprise a phosphorescent material, which can be any known phosphorescent material (referring to patent numbers of U.S. 20020190250A1, WO 01/41512A and WO 00/57676A). In this embodiment, the phosphorescent material is at least one selected from the group consisting of the following formulas (2), (3), (4), (5), (6) and (7):

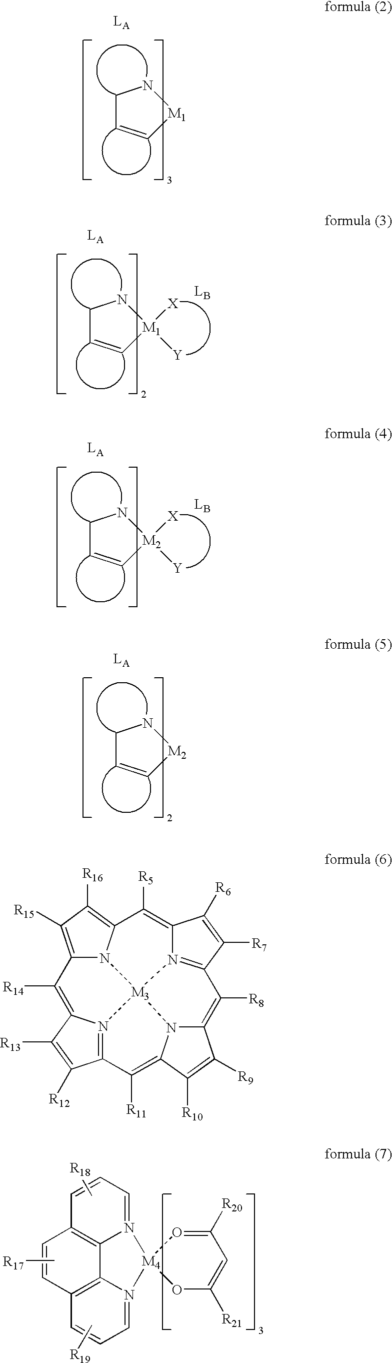

Wherein, in the formulas (2), (3), (4) and (5), M₁ is selected from the group consisting of iridium, rhodium, ruthenium and osmium, M₂ is selected from the group consisting of platinum and palladium, and L_{A} comprises a nitrogen atom and a SP² hybridized carbon atom for bonding with the metal M. In the embodiment, L_{A} is selected from the group consisting of L_{A}1, L_{A}2, L_{A}3, L_{A}4, L_{A}5, L_{A}6, L_{A}7, L_{A}8, L_{A}9, L_{A}10, L_{A}11, L_{A}12, L_{A}13, L_{A}14 and L_{A}15 as shown in the following formulas: 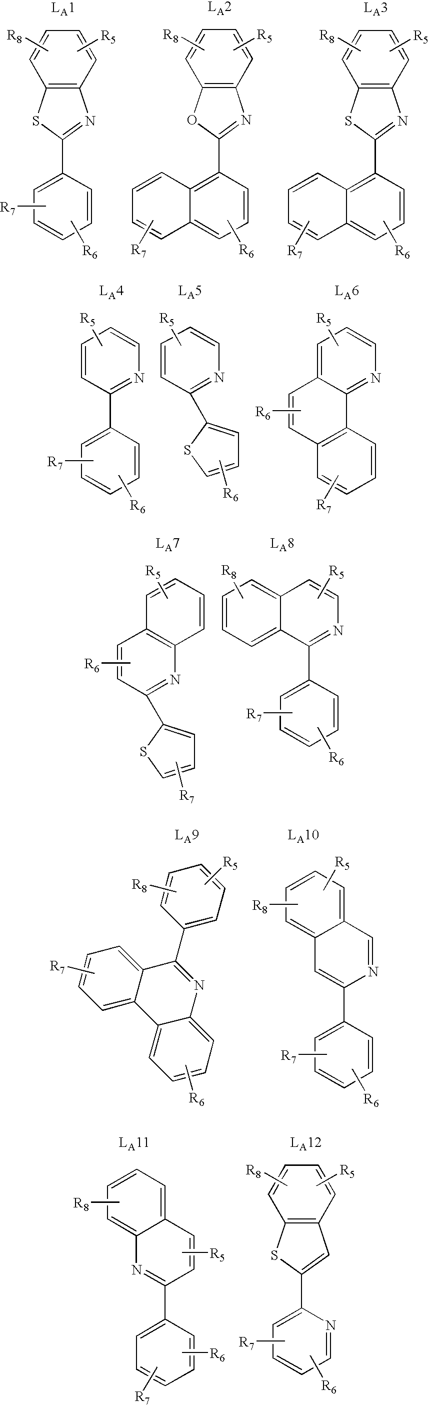 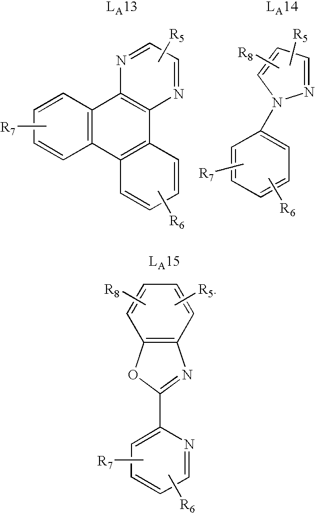
Wherein, R₅, R₆, R₇, R₈ are one selected from the group consisting of hydrogen atom, halogen atom, alkyl group, alkoxyl group, aryl group, electron donating group and electron withdrawing group. L_{B} is one of anion bidentate ligands such as the following L_{B}1, L_{B}2, L_{B}3, L_{B}4, L_{B}5, L_{B}6 or L_{B}7:

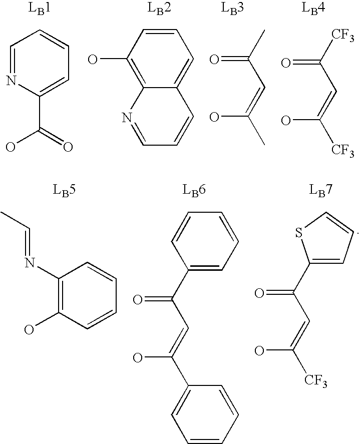

In the formula (6), M₃ is selected from the group consisting of platinum and palladium, R₉, R₁₂, R₁₅, R₁₈ are one selected from the group consisting of hydrogen atom, halogen atom, thienyl and alkyl group, and R₁₀, R₁₁, R₁₃, R₁₄, R₁₆, R₁₇, R₁₉, R₂₀ are one selected from the group consisting of hydrogen atom, halogen atom, alkyl group, alkoxyl group, thienyl, aryl group, electron donating group and electron withdrawing group.

In the formula (7), M₄ is selected from the group consisting of europium, R₂₁, R₂₂, R₂₃ are one selected from the group consisting of hydrogen atom, halogen atom, alkyl group, alkoxyl group, thienyl, aryl group, electron donating group and electron withdrawing group, and R₂₄ and R₂₅ are one selected from the group consisting of alkyl group, aryl group, thienyl, and alkyl halide group. In the current embodiment, the phosphorescent material could be a nano sized powder.

Accordingly, the phosphorescent material of the first embodiment is any compound of, for example, the following formulas:

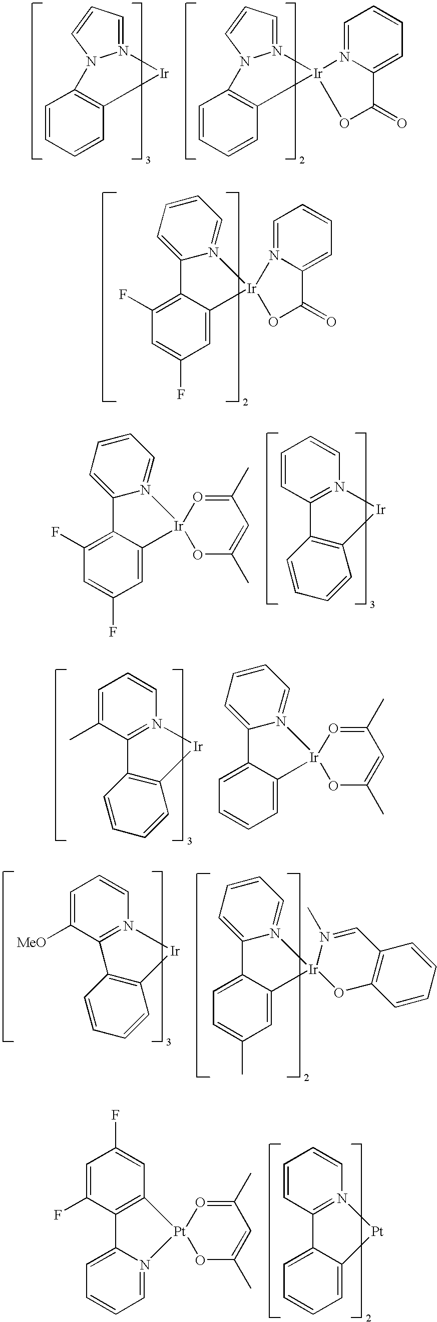

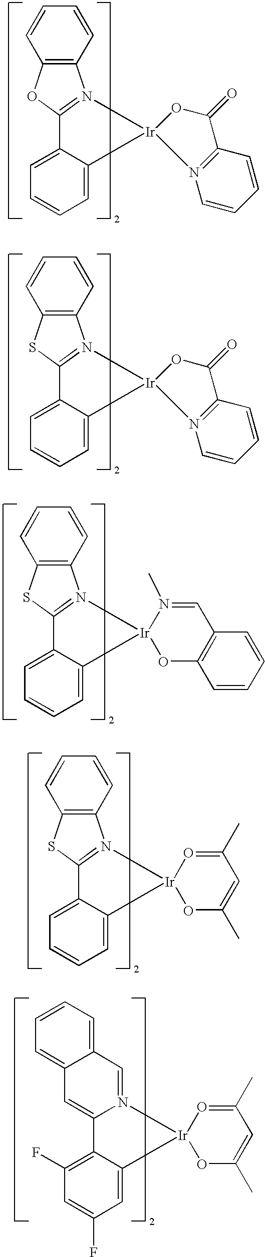

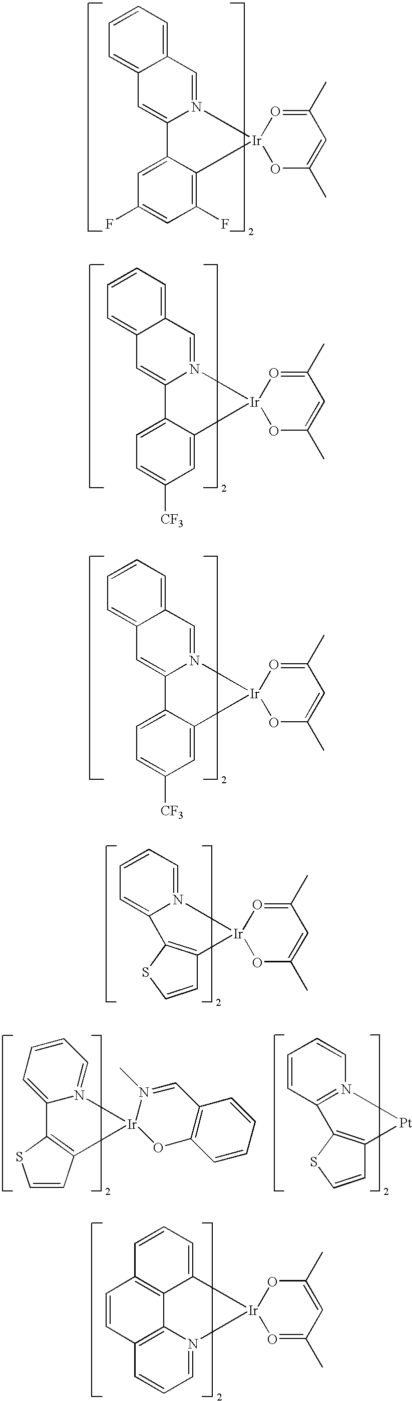

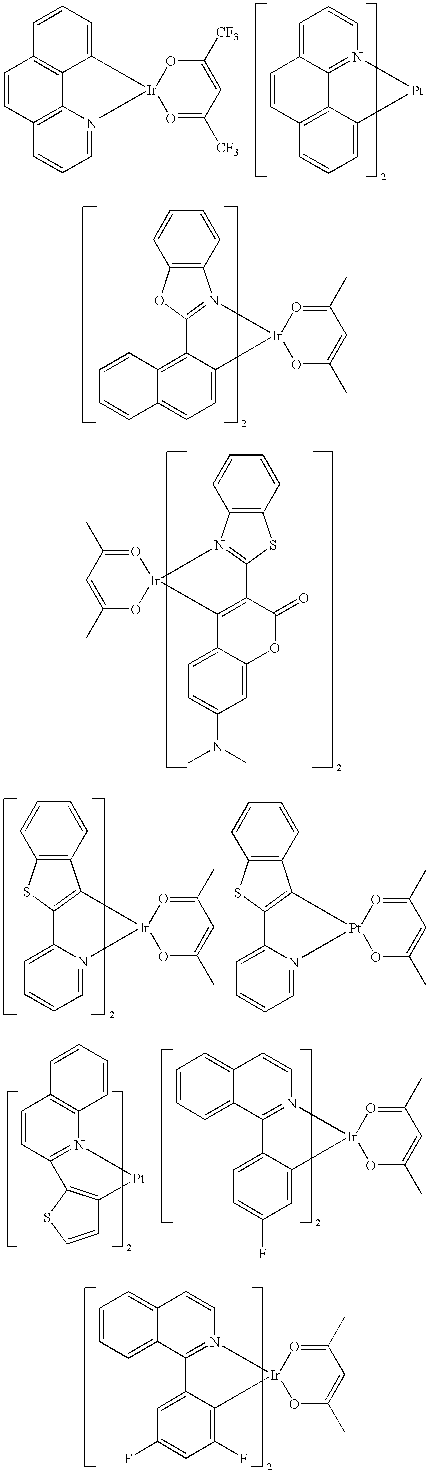

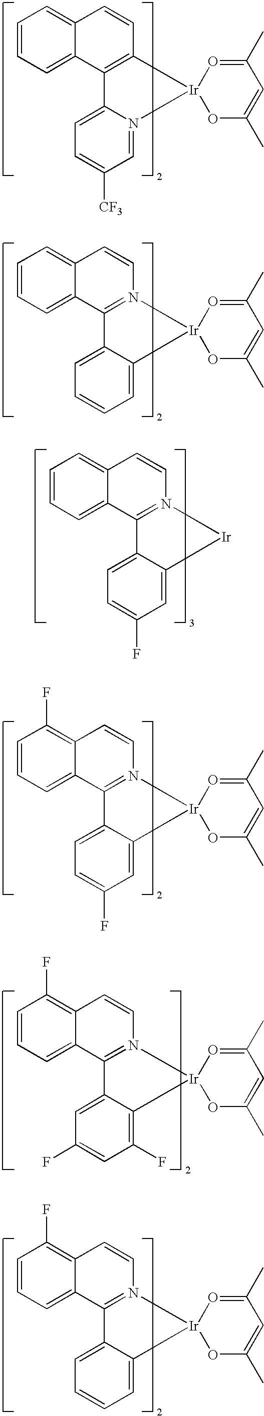

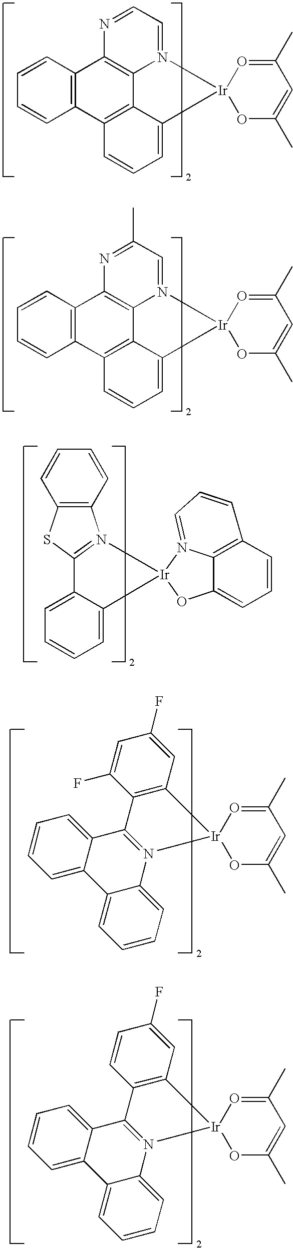

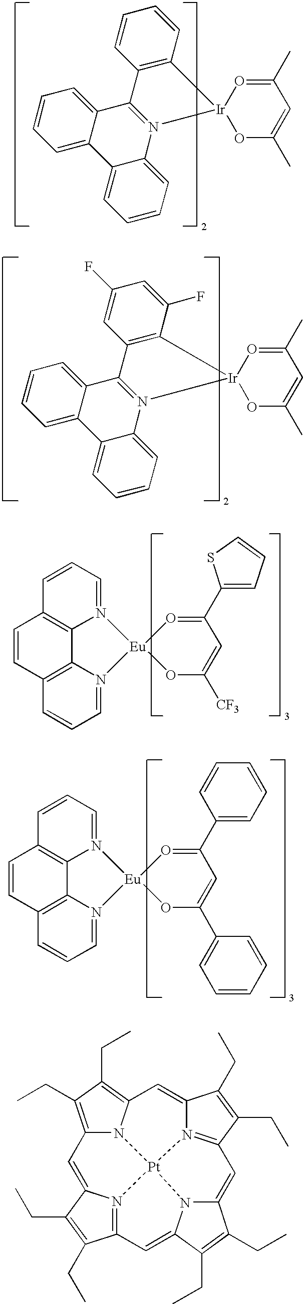

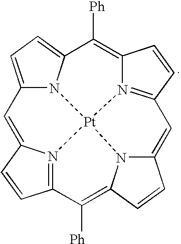

In this embodiment, the phosphorescent material is ranged from 0.5 wt % to 20 wt % of the light-emitting layer 11.

In addition, the second electrode 14 is disposed over the light-emitting layer 11. Herein, the second electrode 14 can be formed by evaporation or sputtering. The material of the second electrode 14 can be but not limited to aluminum, calcium, magnesium, indium, zinc, manganese, silver, gold and magnesium alloy. The magnesium alloy can be, for example but not limited to, Mg:Ag alloy, Mg:In alloy, Mg:Sn alloy, Mg:Sb alloy or Mg:Te alloy.

Of course, the organic electroluminescent device 1 may further comprise a hole-transporting layer 15 disposed between the first electrode 13 and the light-emitting layer 11.

Furthermore, the organic electroluminescent device 1 may further comprise a hole-injecting layer 16 disposed between the first electrode 13 and the light-emitting layer 11.

In the embodiment, the hole-transporting layer 15 and hole-injecting layer 16 may comprise one of triarylamine group compounds such as, for example but not limited to, the previously mentioned formulas (H-3) to (H-16).

Certainly, the organic electroluminescent device 1 may also comprise a hole-blocking layer 17, which is disposed between the light-emitting layer 11 and the second electrode 14. The hole-blocking layer 17 functions to block the delivering hole(s) and has a HOMO (Ip) value higher than that of the light-emitting layer 11.

Of course, the organic electroluminescent device 1 may further comprise an electron-transporting layer 18 disposed between the light-emitting layer 11 and the second electrode 14.

Herein, the common-used material of the hole-blocking layer 17 and electron-transporting layer 18 can be but not limited to one compound of the following formulas (E-1) to (E-7):

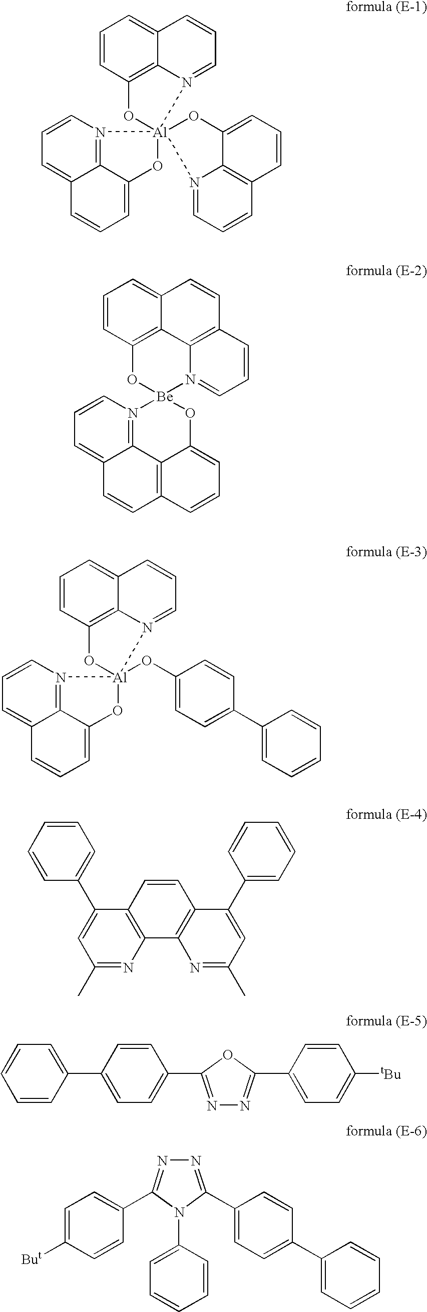

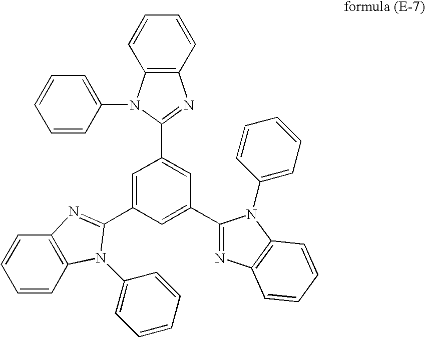

Furthermore, the organic electroluminescent device 1 may further comprise an electron-injecting layer 19 disposed between the light-emitting layer 11 and the second electrode 14.

The above-mentioned hole-injecting layer 16, hole-transporting layer 15, light-emitting layer 11, hole-blocking layer 17, electron-transporting layer 18 and electron-injecting layer 19 are integrally named an organic functional layer.

As mentioned above, the organic functional layer usually comprises one or more stacked structure, and herein below are examples of the structure of the organic functional layer between the first electrode and the second electrode:
(1) first electrode/hole-transporting layer/light-emitting layer/electron-transporting layer/second electrode;
(2) first electrode/hole-transporting layer/light-emitting layer/electron-transporting layer/electron-injecting layer/second electrode;
(3) first electrode/hole-transporting layer/light-emitting layer/hole-blocking layer/electron-transporting layer/electron-injecting layer/second electrode;
(4) first electrode/hole-injecting layer/hole-transporting layer/light-emitting layer/hole-blocking layer/electron-transporting layer/electron-injecting layer/second electrode;
(5) first electrode/hole-injecting layer/hole-transporting layer/light-emitting layer/electron-transporting layer/electron-injecting layer/second electrode;
(6) first electrode/hole-injecting layer/light-emitting layer/electron-transporting layer/electron-injecting layer/second electrode;
(7) first electrode/hole-injecting layer/light-emitting layer/hole-blocking layer/electron-transporting layer/electron-injecting layer/second electrode;
(8) first electrode/light-emitting layer/electron-transporting layer/electron-injecting layer/second electrode; and
(9) first electrode/light-emitting layer/hole-blocking layer/electron-transporting layer/electron-injecting layer/second electrode.

### Second Embodiment

An organic electroluminescent material according to the second embodiment of the invention is used for a hole-transporting light-emitting layer of an organic electroluminescent device. The organic electroluminescent material is of the formula (8): 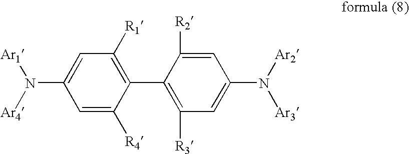
wherein R₁′, R₂′, R₃′, R₄′ are one selected from the group consisting of hydrogen atom, substituted or unsubstituted alkyl group having 1 to 6 carbon atoms and substituted or unsubstituted aryl group having 6 to 40 carbon atoms, and Ar₁′, Ar₂′, Ar₃′, Ar₄′ are a substituted or unsubstituted aryl group having 6 to 40 carbon atoms.

In the present embodiment, the hole-transporting light-emitting layer has integrated functions of both functions of the conventional hole-transporting layer and light-emitting layer. The organic light-emitting layer of the embodiment is comprised in this hole-transporting light-emitting layer.

The functions and features of the organic electroluminescent material, organic electroluminescent device, hole-transporting layer and light-emitting layer of the second embodiment are the same as those mentioned in the first embodiment, so the detailed descriptions are omitted hereinafter for concise purpose.

### Third Embodiment

An organic electroluminescent device according to the third embodiment of the invention comprises a substrate, a first electrode, a second electrode and a light-emitting layer. The first electrode, the light-emitting layer and the second electrode are disposed over the substrate in sequence. The light-emitting layer comprises a phosphorescent material and an organic electroluminescent material of the formula (15): 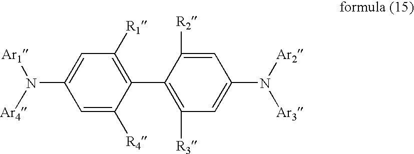
wherein R₁″, R₂″, R₃″, R₄″ are one selected from the group consisting of hydrogen atom, substituted or unsubstituted alkyl group having 1 to 6 carbon atoms and substituted or unsubstituted aryl group having 6 to 40 carbon atoms, and Ar₁″, Ar₂″, Ar₃″, Ar₄″ are a substituted or unsubstituted aryl group having 6 to 40 carbon atoms.

The organic electroluminescent device of the embodiment may further comprise a hole-injecting layer, a hole-transporting layer, a hole-blocking layer, an electron-transporting layer, an electron-injecting layer and their combination.

The functions and features of all elements of the third embodiment are the same as those mentioned in the first embodiment, so the detailed descriptions are omitted hereinafter for concise purpose.

### Fourth Embodiment

The organic electroluminescent device according to the fourth embodiment of the invention comprises a substrate, a first electrode, a second electrode and a hole-transporting light-emitting layer. The first electrode, the hole-transporting light-emitting layer and the second electrode are disposed over the substrate in sequence. The hole-transporting light-emitting layer comprises a phosphorescent material and an organic electroluminescent material of the formula (22): 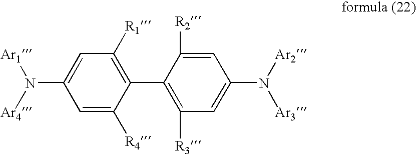
wherein R₁′″, R₂′″, R₃′″, R₄′″ are one selected from the group consisting of hydrogen atom, substituted or unsubstituted alkyl group having 1 to 6 carbon atoms and substituted or unsubstituted aryl group having 6 to 40 carbon atoms, and Ar₁′″, Ar₂′″, Ar₃′″, Ar₄′″ are a substituted or unsubstituted aryl group having 6 to 40 carbon atoms.

The organic electroluminescent device of the embodiment may further comprise a hole-injecting layer, a hole-blocking layer, an electron-transporting layer, an electron-injecting layer and their combination.

The functions and features of all elements of the fourth embodiment are the same as those mentioned in the second embodiment, so the detailed descriptions are omitted hereinafter for concise purpose.

To make the above-mentioned embodiments more comprehensive, several examples, a comparison, and a half-life experiment are illustrated hereinafter.

### EXAMPLE 1

First, a 100 mm×100 mm substrate is provided, wherein an ITO layer with a thickness of 110 nm is formed over the substrate. After photolithography and patterning processes, a pattern of 10 mm×10 mm emitting region is defined. In the condition of 10⁻⁵ Pa, a hole-injecting layer with a thickness of 10 nm is formed, and the evaporation ratio of the hole-injecting material (of the above-mentioned formula H-11) is maintained at 0.2 nm/sec. Then, a hole-transporting layer with a thickness of 40 nm is coated, and the evaporation ratio of the hole-transporting material (of the above-mentioned formula H-9) is maintained at 0.2 nm/sec. After that, a light-emitting layer with a thickness of 30 nm is formed by a co-evaporating method, and the evaporation ratio of the materials including TD-1 and the above-mentioned formula H-9 is maintained at 0.2 nm/sec, wherein the TD-1 is 8 wt % of the light-emitting layer. The material of above-mentioned formula E-3 is then formed to be a hole-blocking layer with a thickness of 10 nm. Then, an electron-transporting layer with a thickness of 30 nm is formed, and the evaporation ratio of the material of the above-mentioned formula E-2 is maintained at 0.2 nm/sec. Finally, lithium fluoride (LiF) and aluminun (Al) are formed over the electron-transporting layer as a cathode, and have a thickness of 1.2 nm and 150 nm, respectively. Following the steps, an organic electroluminescent device according to an embodiment of this invention is completed.

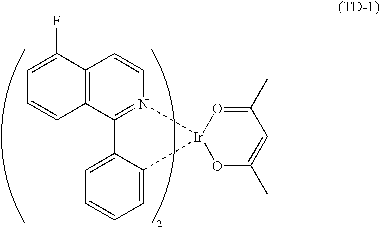

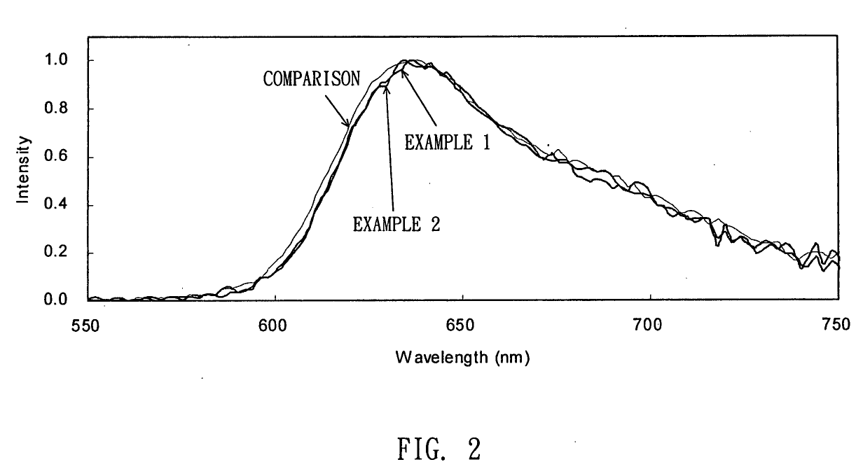

In this case, the luminescent qualities of the organic electroluminescent device according to the embodiment are driven by direct current and are measured by using Keithly 2000. Accordingly, the organic electroluminescent device emits red light. Furthermore, the EL spectrum of the organic electroluminescent device is measured using a spectrum meter manufactured by Otsuka Electronic Co., wherein the detector is a photodiode array. In this case, the spectrum is shown in FIG. 2, and a luminescent wavelength of 638 nm is obtained. Studying the current vs. luminance (I-B) curve and the current vs. voltage (I-V) curve of the manufactured organic electroluminescent device, we can find that when 7.5 volts are applied, the luminance of the organic electroluminescent device is 3335 cd/m², the current density is 86 mA/cm², the efficiency is 1.88 lm/W or 3.88 cd/A, and the C.I.E. chromaticity coordinates are (X=0.68, Y=0.31).

### EXAMPLE 2

With reference to the procedures of EXAMPLE 1, a hole-injecting layer with a thickness of 30 nm is formed, and the evaporation ratio of the hole-injecting material (of the above-mentioned formula H-11) is maintained at 0.2 nm/sec. Then, a light-emitting layer with a thickness of about 50 nm is formed by a co-evaporating method, and the evaporation ratio of the materials including TD-1 and the above-mentioned formula H-9 is maintained at 0.2 nm/sec, wherein the TD-1 is 8 wt % of the light-emitting layer. After that, the material of above-mentioned formula E-3 is formed to be a hole-blocking layer with a thickness of 10 nm. Then, an electron-transporting layer with a thickness of 30 nm is formed, and the evaporation ratio of the material of the above-mentioned formula E-2 is maintained at 0.2 nm/sec. Finally, lithium fluoride (LiF) and aluminun (Al) are formed over the electron-transporting layer as a cathode, and have a thickness of 1.2 nm and 150 nm, respectively. Following the steps, an organic electroluminescent device according to an embodiment of this invention is completed.

In this case, the luminescent qualities of the organic electroluminescent device according to the embodiment are driven by direct current and are measured by using Keithly 2000. Accordingly, the organic electroluminescent device emits red light. Furthermore, the EL spectrum of the organic electroluminescent device is measured using a spectrum meter manufactured by Otsuka Electronic Co., wherein the detector is a photodiode array. In this case, the spectrum is shown in FIG. 2, and a luminescent wavelength of 638 nm is obtained. Studying the current vs. luminance (I-B) curve and the current vs. voltage (I-V) curve of the manufactured organic electroluminescent device, we can find that when 7.5 volts are applied, the luminance of the organic electroluminescent device is 4672 cd/m², the current density is 102 mA/cM², the efficiency is 1.93 lm/W or 4.60 cd/A, and the C.I.E. chromaticity coordinates are (X=0.68, Y=0.31).

### Comparison

With reference to the procedures of EXAMPLE 1, a hole-injecting layer with a thickness of 10 nm is formed, and the evaporation ratio of the hole-injecting material (of the above-mentioned formula H-11) is maintained at 0.2 nm/sec. Then, a hole-transporting layer with a thickness of 40 nm is formed, and the evaporation ratio of the hole-transporting material (of the above-mentioned formula H-9) is maintained at 0.2 nm/sec. After that, a light-emitting layer with a thickness of about 30 nm is formed by a co-evaporating method, and the evaporation ratio of the materials including TD-1 and the above-mentioned formula H-9 is maintained at 0.2 nm/sec, wherein the TD-1 is 8 wt % of the light-emitting layer. The material of above-mentioned formula E-4 is then formed to be a hole-blocking layer with a thickness of 10 nm. Then, an electron-transporting layer with a thickness of 30 nm is formed, and the evaporation ratio of the material of the above-mentioned formula E-2 is maintained at 0.2 nm/sec. Finally, lithium fluoride (LiF) and aluminun (Al) are formed on the electron-transporting layer as a cathode, and have a thickness of 1.2 nm and 150 nm, respectively. Following the steps, an organic electroluminescent device according to the comparison case is completed.

In this comparison case, the luminescent qualities of the organic electroluminescent device according to the embodiment are driven by direct current and are measured by using Keithly 2000. Accordingly, the organic electroluminescent device emits red light. Furthermore, the EL spectrum of the organic electroluminescent device is measured using a spectrum meter manufactured by Otsuka Electronic Co., wherein the detector is a photodiode array. In this case, the spectrum is shown in FIG. 2, and a luminescent wavelength of 638 nm is obtained. Studying the current vs. luminance (I-B) curve and the current vs. voltage (I-V) curve of the manufactured organic electroluminescent device, we can find that when 7.5 volts are applied, the luminance of the organic electroluminescent device is 3657 cd/m², the current density is 78 mA/cm², the efficiency is 1.55 lm/W or 4.68 cd/A, and the C.I.E. chromaticity coordinates are (X=0.69, Y=0.31).

### Half-Life Experiment

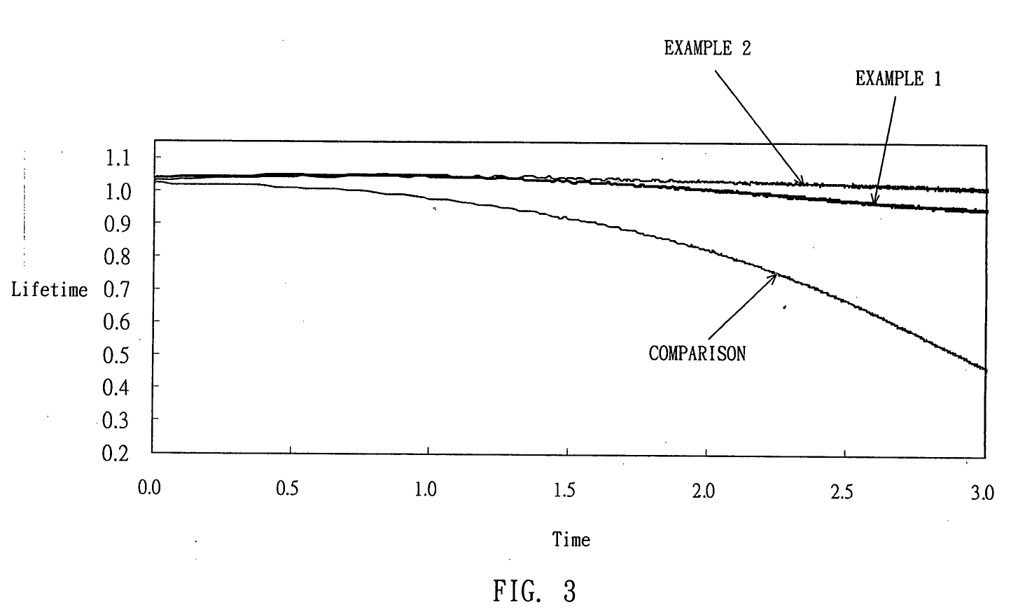

The manufactured devices are operated under a room temperature and a constant current density of 40 mA/cm², and the results of the luminescent versus time are shown in FIG. 3. It is obvious that the half-lives of the devices according to the EXAMPLE 1 and EXAMPLE 2 are greatly improved than that of the device according to the COMPARISON.

In summary, the organic electroluminescent material and organic electroluminescent device of the invention comprise the compound containing triarylamine group and excluding carbazole derivative compounds. Compared with the prior art, the organic electroluminescent material of this invention has a higher stability so as to prolong the lifetime of the organic electroluminescent device. In addition, the light-emitting layer and hole-transporting layer can be integrated since the organic electroluminescent material has excellent hole-transporting ability. Accordingly, the complexity of the layers of the device can be decreased, the manufacturing processes of the organic functional layer can be greatly simplified, and the organic electroluminescent device with a high efficiency and longer lifetime can be efficiently produced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An organic electroluminescent material, which is for using in a light-emitting layer or a hole-transporting light-emitting layer of an organic electroluminescent device, of the formula (1): 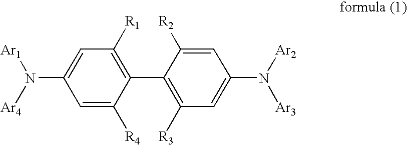
wherein R₁, R₂, R₃, R₄ are one selected from the group consisting of hydrogen atom, substituted or unsubstituted alkyl group having 1 to 6 carbon atoms and substituted or unsubstituted aryl group having 6 to 40 carbon atoms, Ar₁, Ar₂, Ar₃, Ar₄ are a substituted or unsubstituted aryl group having 6 to 40 carbon atoms.

2. The organic electroluminescent material of claim 1, wherein the substituted alkyl group having 1 to 6 carbon atoms is selected from the group consisting of substituted methyl, substituted ethyl, substituted propyl, substituted isopropyl, substituted butyl, substituted isobutyl, substituted 2-butyl, substituted 3-butyl, substituted linear chain pentyl, substituted branched pentyl, substituted linear chain hexyl and substituted side chain hexyl, the unsubstituted alkyl group having 1 to 6 carbon atoms is selected from the group consisting of methyl, ethyl, propyl, isopropyl, butyl, isobutyl, 2-butyl, 3-butyl, linear chain pentyl, branched pentyl, linear chain hexyl and side chain hexyl, the substituted aryl group having 6 to 40 carbon atoms is selected from the group consisting of substituted phenyl, substituted naphthyl, substituted anthracyl, substituted phenanthryl, substituted pyryl, substituted biphenylyl, substituted triphenylyl, substituted triphenylamine, substituted furan, substituted thiophene and substituted indole, and the unsubstituted aryl group having 6 to 40 carbon atoms is selected from the group consisting of phenyl, naphthyl, anthracyl, phenanthryl, pyryl, biphenylyl, triphenylyl, triphenylamine, furan, thiophene and indole.

3. The organic electroluminescent material of claim 2, wherein the substituent group of the substituted aryl group having 6 to 40 carbon atoms is selected from the group consisting of alkyl group having 1 to 6 carbon atoms, cycloalkyl group having 3 to 6 carbon atoms, alkoxyl group having 1 to 6 carbon atoms, aryloxy having 5 to 18 carbon atoms, aralkoxy having 7 to 18 carbon atoms, amino substituted with aryl group having 5 to 16 carbon atoms, nitro group, cyano group, ester group having 1 to 6 carbon atoms and halogen.

4. The organic electroluminescent material of claim 3, wherein the alkyl group having 1 to 6 carbon atoms as the substituent group is selected from the group consisting of methyl, ethyl, propyl, isopropyl, butyl, isobutyl, 2-butyl, 3-butyl, linear chain pentyl, branched pentyl, linear chain hexyl and branched hexyl, the cycloalkyl group having 3 to 6 carbon atoms as the substituent group is selected from the group consisting of cyclopropyl, cyclobutyl, cyclopentyl and cyclohexyl, the alkoxyl group having 1 to 6 carbon atoms as the substituent group is selected from the group consisting of methoxyl, ethoxyl, propoxyl, isopropoxyl, butoxyl, isobutoxyl, 2-butoxyl, 3-butoxyl, linear chain pentyloxyl, branched pentyloxyl, linear chain hexoxyl and branched hexoxyl, the aryloxy having 5 to 18 carbon atoms as the substituent group is selected from the group consisting of phenyloxy, tolyloxy and naphthyloxy, the aralkoxy having 7 to 18 carbon atoms as the substituent group is selected from the group consisting of phenethyloxy and naphthoxyl, and the amino group substituted with aryl group having 5 to 16 carbon atoms as the substituent group is selected from the group consisting of dianilino, xylidino and naththyl aniline.

5. The organic electroluminescent material of claim 1, wherein the light-emitting layer or the hole-transporting light-emitting layer emits phosphorescence.

6. The organic electroluminescent material of claim 1, wherein the light-emitting layer or the hole-transporting light-emitting layer further comprises a phosphorescent material of at least one selected from the group consisting of the formulas (2), (3), (4), (5), (6) and (7): 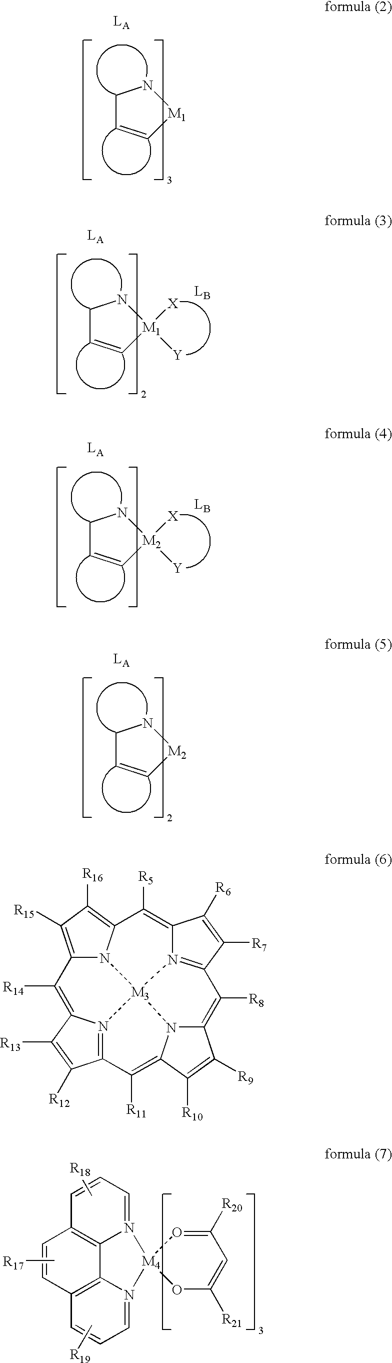
wherein M₁ is selected from the group consisting of iridium, rhodium, ruthenium and osmium, M₂ is selected from the group consisting of platinum and palladium, M₃ is selected from the group consisting of platinum and palladium, M₄ is europium, L_{A} is selected from the group consisting of L_{A}1, L_{A}2, L_{A}3, L_{A}4, L_{A}5, L_{A}6, L_{A}7, L_{A}8, L_{A}9, L_{A}10, L_{A}11, L_{A}12, L_{A}13, L_{A}14 and L_{A}15, L_{B} is selected from the group consisting of L_{B}1, L_{B}2, L_{B}3, L_{B}4, L_{B}5, L_{B}6 and L_{B}7, R₅, R₆, R₇, R₈ are one selected from the group consisting of hydrogen atom, halogen atom, alkyl group, alkoxyl group, aryl group, electron donating group and electron withdrawing group, R₉, R₁₂, R₁₅, R₁₈ are one selected from the group consisting of hydrogen atom, alkyl group, thienyl and aryl group, R₁₀, R₁₁, R₁₃, R₁₄, R₁₆, R₁₇, R₁₉, R₂₀ are one selected from the group consisting of hydrogen atom, halogen atom, alkyl group, alkoxyl group, thienyl, aryl group, electron donating group and electron withdrawing group, R₂₁, R₂₂, R₂₃ are one selected from the group consisting of hydrogen atom, halogen atom, alkyl group, alkoxyl group, thienyl, aryl group, electron donating group and electron withdrawing group, R₂₄ and R₂₅ are one selected from the group consisting of alkyl group, aryl group, thienyl, and alkyl halide group, and wherein

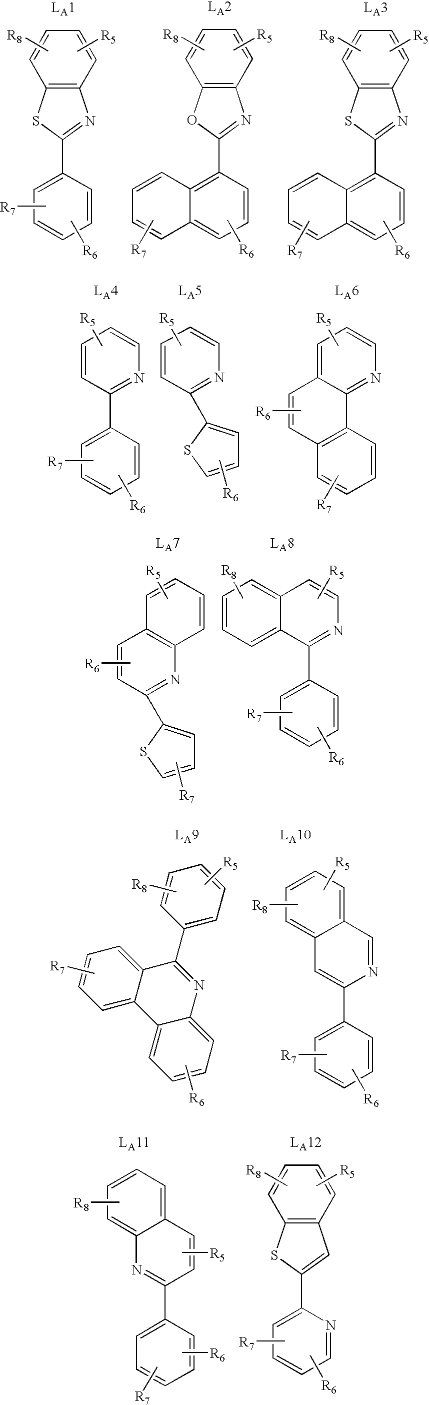

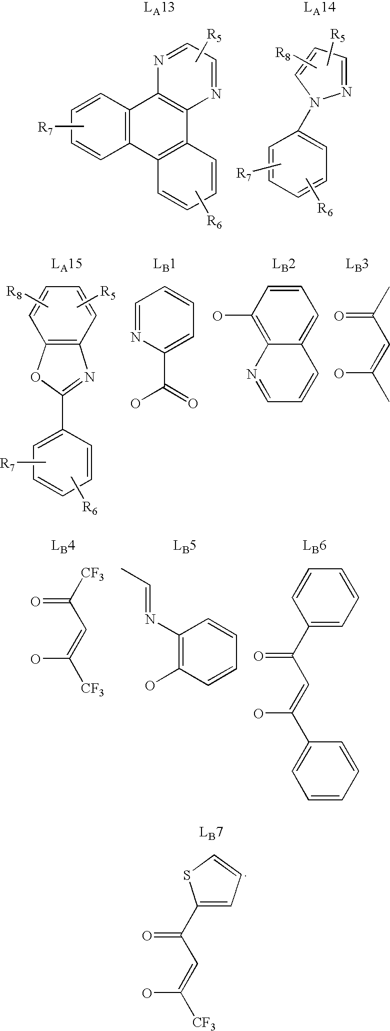

7. The organic electroluminescent material of claim 6, wherein the phosphorescent material is ranged from 0.5 wt % to 20 wt % of the light-emitting layer or the hole-transporting light-emitting layer.

8. An organic electroluminescent device, comprising:
a substrate;
a first electrode;
a second electrode; and
a light-emitting layer, wherein the first electrode, the light-emitting layer and the second electrode are disposed over the substrate in sequence, and the light-emitting layer comprises a phosphorescent material and an organic electroluminescent material of the formula (15): 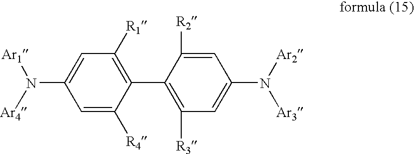
wherein R₁″, R₂″, R₃″, R₄″ are one selected from the group consisting of hydrogen atom, substituted or unsubstituted alkyl group having 1 to 6 carbon atoms and substituted or unsubstituted aryl group having 6 to 40 carbon atoms, Ar₁″, Ar₂″, Ar₃″, Ar₄″ are a substituted or unsubstituted aryl group having 6 to 40 carbon atoms.

9. The organic electroluminescent device of claim 8, wherein the substituted alkyl group having 1 to 6 carbon atoms is selected from the group consisting of substituted methyl, substituted ethyl, substituted propyl, substituted isopropyl, substituted butyl, substituted isobutyl, substituted 2-butyl, substituted 3-butyl, substituted linear chain pentyl, substituted branched pentyl, substituted linear chain hexyl and substituted side chain hexyl, the unsubstituted alkyl group having 1 to 6 carbon atoms is selected from the group consisting of methyl, ethyl, propyl, isopropyl, butyl, isobutyl, 2-butyl, 3-butyl, linear chain pentyl, branched pentyl, linear chain hexyl and side chain hexyl, the substituted aryl group having 6 to 40 carbon atoms is selected from the group consisting of substituted phenyl, substituted naphthyl, substituted anthracyl, substituted phenanthryl, substituted pyryl, substituted biphenylyl, substituted triphenylyl, substituted triphenylamine, substituted furan, substituted thiophene and substituted indole, and the unsubstituted aryl group having 6 to 40 carbon atoms is selected from the group consisting of phenyl, naphthyl, anthracyl, phenanthryl, pyryl, biphenylyl, triphenylyl, triphenylamine, furan, thiophene and indole.

10. The organic electroluminescent device of claim 9, wherein the substituent group of the substituted aryl group having 6 to 40 carbon atoms is selected from the group consisting of alkyl group having 1 to 6 carbon atoms, cycloalkyl group having 3 to 6 carbon atoms, alkoxyl group having 1 to 6 carbon atoms, aryloxy having 5 to 18 carbon atoms, aralkoxy having 7 to 18 carbon atoms, amino substituted with aryl group having 5 to 16 carbon atoms, nitro group, cyano group, ester group having 1 to 6 carbon atoms and halogen.

11. The organic electroluminescent device of claim 10, wherein the alkyl group having 1 to 6 carbon atoms as the substituent group is selected from the group consisting of methyl, ethyl, propyl, isopropyl, butyl, isobutyl, 2-butyl, 3-butyl, linear chain pentyl, branched pentyl, linear chain hexyl and branched hexyl, the cycloalkyl group having 3 to 6 carbon atoms as the substituent group is selected from the group consisting of cyclopropyl, cyclobutyl, cyclopentyl and cyclohexyl, the alkoxyl group having 1 to 6 carbon atoms as the substituent group is selected from the group consisting of methoxyl, ethoxyl, propoxyl, isopropoxyl, butoxyl, isobutoxyl, 2-butoxyl, 3-butoxyl, linear chain pentyloxyl, branched pentyloxyl, linear chain hexoxyl and branched hexoxyl, the aryloxy having 5 to 18 carbon atoms as the substituent group is selected from the group consisting of phenyloxy, tolyloxy and naphthyloxy, the aralkoxy having 7 to 18 carbon atoms as the substituent group is selected from the group consisting of phenethyloxy and naphthoxyl, and the amino group substituted with aryl group having 5 to 16 carbon atoms as the substituent group is selected from the group consisting of dianilino, xylidino and naththyl aniline.

12. The organic electroluminescent device of claim 8, wherein the phosphorescent material is at least one selected from the group consisting of the formulas (16), (17), (18), (19), (20) and (21): 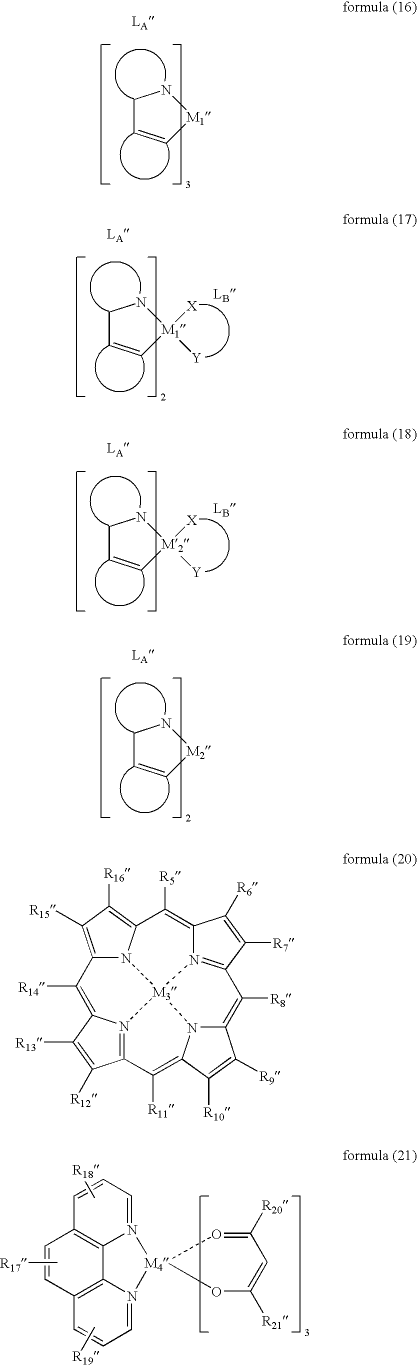
wherein M₁″ is selected from the group consisting of iridium, rhodium, ruthenium and osmium, M₂″ is selected from the group consisting of platinum and palladium, M₃″ is selected from the group consisting of platinum and palladium, M₄″ is europium, L_{A}″ is selected from the group consisting of L_{A}1″, L_{A}2″, L_{A}3″, L_{A}4″, L_{A}5″, L_{A}6″, L_{A}7″, L_{A}8″, L_{A}9″, L_{A}10″, L_{A}11″, L_{A}12″, L_{A}13″, L_{A}14″ and L_{A}15″, L_{B}″ is selected from the group consisting of L_{B}1″, L_{B}2″, L_{B}3″, L_{B}4″, L_{B}5″, L_{B}6″ and L_{B}7″, R₅″, R₆″, R₇″, R₈″ are one selected from the group consisting of hydrogen atom, halogen atom, alkyl group, alkoxyl group, aryl group, electron donating group and electron withdrawing group, R₉″, R₁₂″, R₁₅″, R₁₈″ are one selected from the group consisting of hydrogen atom, alkyl group, thienyl and aryl group, R₁₀″, R₁₁″, R₁₃″, R₁₄″, R₁₆″, R₁₇″, R₁₉″, R₂₀″ are one selected from the group consisting of hydrogen atom, halogen atom, alkyl group, alkoxyl group, thienyl, aryl group, electron donating group and electron withdrawing group, R₂₁″, R₂₂″, R₂₃″ are one selected from the group consisting of hydrogen atom, halogen atom, alkyl group, alkoxyl group, thienyl, aryl group, electron donating group and electron withdrawing group, R₂₄″ and R₂₅″ are one selected from the group consisting of alkyl group, aryl group, thienyl and alkyl halide group, and wherein

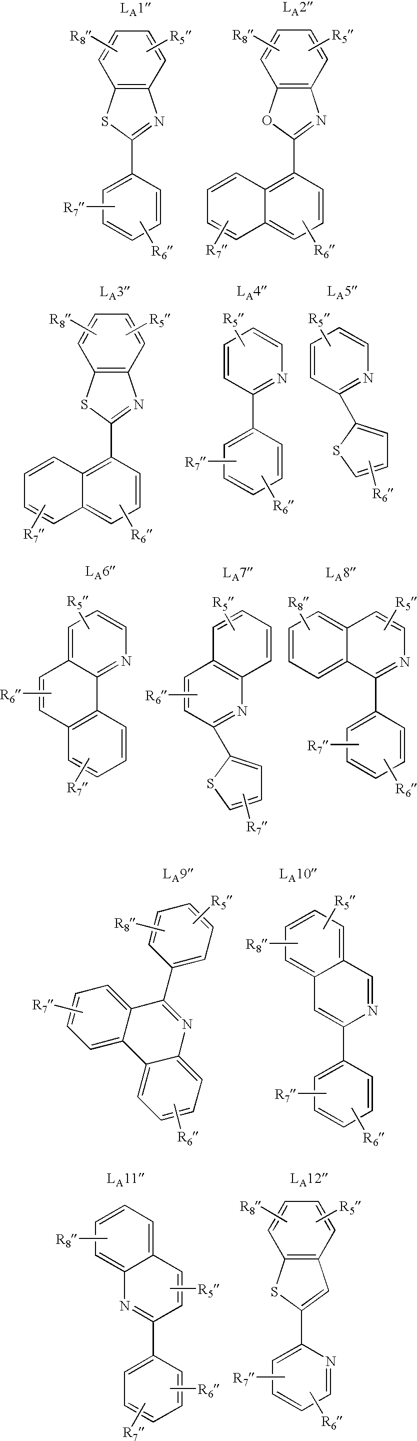

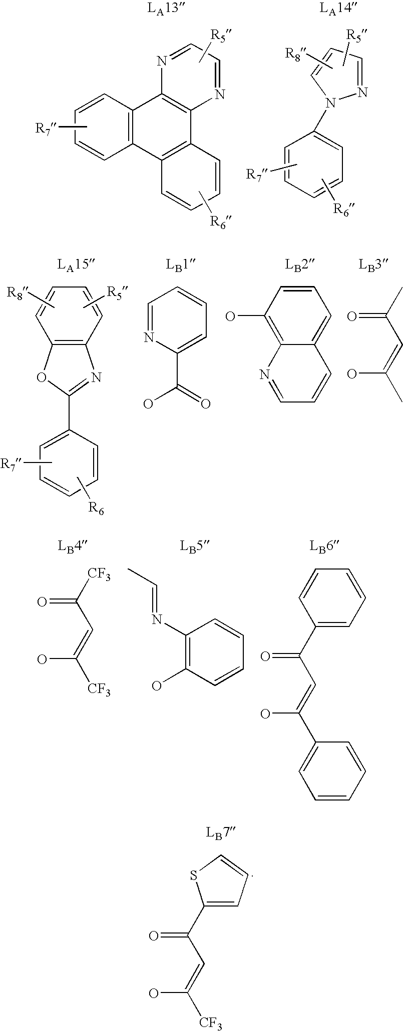

13. The organic electroluminescent device of claim 12, wherein the phosphorescent material is ranged from 0.5 wt % to 20 wt % of the light-emitting layer.

14. An organic electroluminescent device, comprising:
a substrate;
a first electrode;
a second electrode; and
a hole-transporting light-emitting layer, wherein the first electrode, the hole-transporting light-emitting layer and the second electrode are disposed over the substrate in sequence, and the hole-transporting light-emitting layer comprises a phosphorescent material and an organic electroluminescent material of the formula (22): 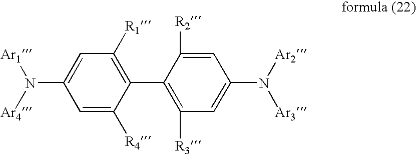
wherein R₁′″, R₂′″, R₃′″, R₄′″ are one selected from the group consisting of hydrogen atom, substituted or unsubstituted alkyl group having 1 to 6 carbon atoms and substituted or unsubstituted aryl group having 6 to 40 carbon atoms, Ar₁′″, Ar₂′″, Ar₃′″, Ar₄′″ are a substituted or unsubstituted aryl group having 6 to 40 carbon atoms.

15. The organic electroluminescent device of claim 14, wherein the substituted alkyl group having 1 to 6 carbon atoms is selected from the group consisting of substituted methyl, substituted ethyl, substituted propyl, substituted isopropyl, substituted butyl, substituted isobutyl, substituted 2-butyl, substituted 3-butyl, substituted linear chain pentyl, substituted branched pentyl, substituted linear chain hexyl and substituted side chain hexyl, the unsubstituted alkyl group having 1 to 6 carbon atoms is selected from the group consisting of methyl, ethyl, propyl, isopropyl, butyl, isobutyl, 2-butyl, 3-butyl, linear chain pentyl, branched pentyl, linear chain hexyl and side chain hexyl, the substituted aryl group having 6 to 40 carbon atoms is selected from the group consisting of substituted phenyl, substituted naphthyl, substituted anthracyl, substituted phenanthryl, substituted pyryl, substituted biphenylyl, substituted triphenylyl, substituted triphenylamine, substituted furan, substituted thiophene and substituted indole, and the unsubstituted aryl group having 6 to 40 carbon atoms is selected from the group consisting of phenyl, naphthyl, anthracyl, phenanthryl, pyryl, biphenylyl, triphenylyl, triphenylamine, furan, thiophene and indole.

16. The organic electroluminescent device of claim 15, wherein the substituent group of the substituted aryl group having 6 to 40 carbon atoms is selected from the group consisting of alkyl group having 1 to 6 carbon atoms, cycloalkyl group having 3 to 6 carbon atoms, alkoxyl group having 1 to 6 carbon atoms, aryloxy having 5 to 18 carbon atoms, aralkoxy having 7 to 18 carbon atoms, amino substituted with aryl group having 5 to 16 carbon atoms, nitro group, cyano group, ester group having 1 to 6 carbon atoms and halogen.

17. The organic electroluminescent device of claim 16, wherein the alkyl group having 1 to 6 carbon atoms as the substituent group is selected from the group consisting of methyl, ethyl, propyl, isopropyl, butyl, isobutyl, 2-butyl, 3-butyl, linear chain pentyl, branched pentyl, linear chain hexyl and branched hexyl, the cycloalkyl group having 3 to 6 carbon atoms as the substituent group is selected from the group consisting of cyclopropyl, cyclobutyl, cyclopentyl and cyclohexyl, the alkoxyl group having 1 to 6 carbon atoms as the substituent group is selected from the group consisting of methoxyl, ethoxyl, propoxyl, isopropoxyl, butoxyl, isobutoxyl, 2-butoxyl, 3-butoxyl, linear chain pentyloxyl, branched pentyloxyl, linear chain hexoxyl and branched hexoxyl, the aryloxy having 5 to 18 carbon atoms as the substituent group is selected from the group consisting of phenyloxy, tolyloxy and naphthyloxy, the aralkoxy having 7 to 18 carbon atoms as the substituent group is selected from the group consisting of phenethyloxy and naphthoxyl, and the amino group substituted with aryl group having 5 to 16 carbon atoms as the substituent group is selected from the group consisting of dianilino, xylidino and naththyl aniline.

18. The organic electroluminescent device of claim 14, wherein the phosphorescent material is at least one selected from the group consisting of the formulas (23), (24), (25), (26), (27) and (28): 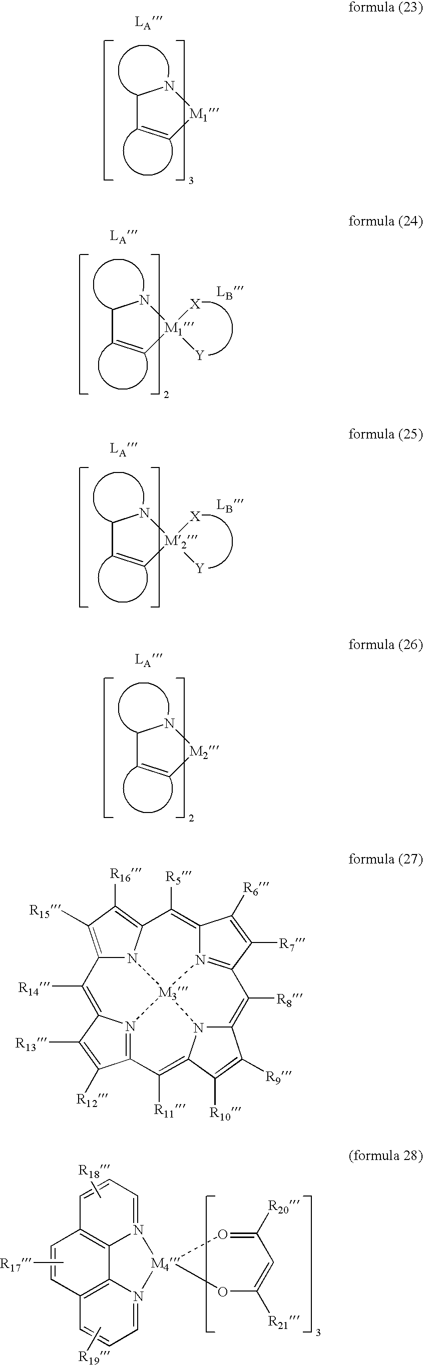
wherein M₁′″ is selected from the group consisting of iridium, rhodium, ruthenium and osmium, M₂′″ is selected from the group consisting of platinum and palladium, M₃′″ is selected from the group consisting of platinum and palladium, M₄′″ is europium, L_{A}′″ is selected from the group consisting of L_{A}1′″, L_{A}2′″, L_{A}3′″, L_{A}4′″, L_{A}5′″, L_{A}6′″, L_{A}7′″, L_{A}8′″, L_{A}9′″, L_{A}10′″, L_{A}11′″, L_{A}12′″, L_{A}13′″, L_{A}14′″ and L_{A}15′″, L_{B}′″ is selected from the group consisting of L_{B}1′″, L_{B}2′″, L_{B}3′″, L_{B}4′″, L_{B}5′″, L_{B}6′″ and L_{B}7′″, R₅′″, R₆′″, R₇′″, R₈′″ are one selected from the group consisting of hydrogen atom, halogen atom, alkyl group, alkoxyl group, aryl group, electron donating group and electron withdrawing group, R₉′″, R₁₂′″, R₁₅′″, R₁₈′″ are one selected from the group consisting of hydrogen atom, alkyl group, thienyl and aryl group, R₁₀′″, R₁₁′″, R₁₃′″, R₁₄′″, R₁₆′″, R₁₇′″, R₁₉′″, R₂₀′″ are one selected from the group consisting of hydrogen atom, halogen atom, alkyl group, alkoxyl group, thienyl, aryl group, electron donating group and electron withdrawing group, R₂₁′″, R₂₂′″, R₂₃″ are one selected from the group consisting of hydrogen atom, halogen atom, alkyl group, alkoxyl group, thienyl, aryl group, electron donating group and electron withdrawing group, R₂₄″ and R₂₅″ are one selected from the group consisting of alkyl group, aryl group, thienyl and alkyl halide group, and wherein

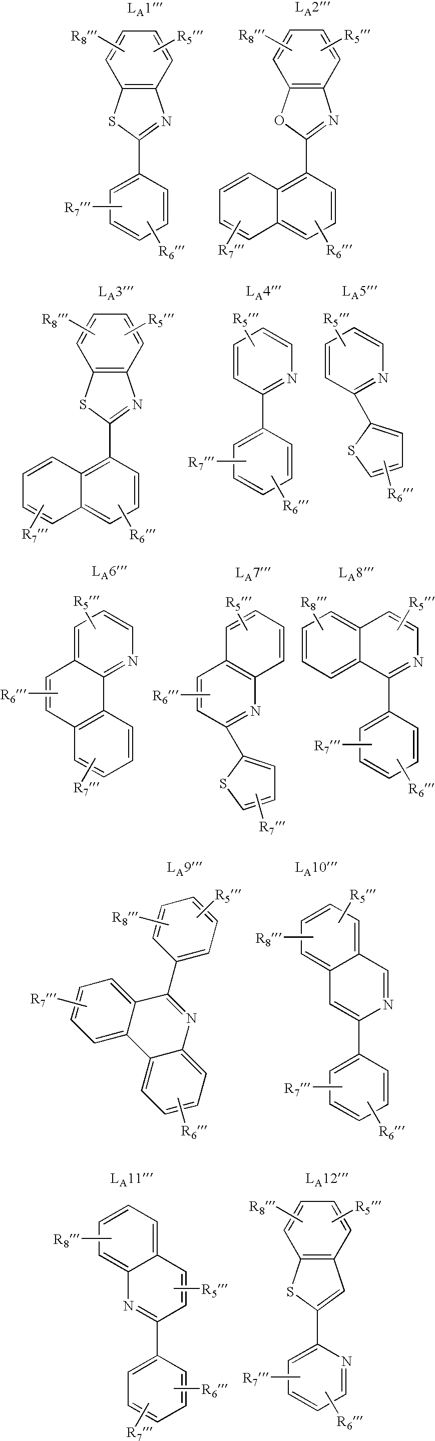

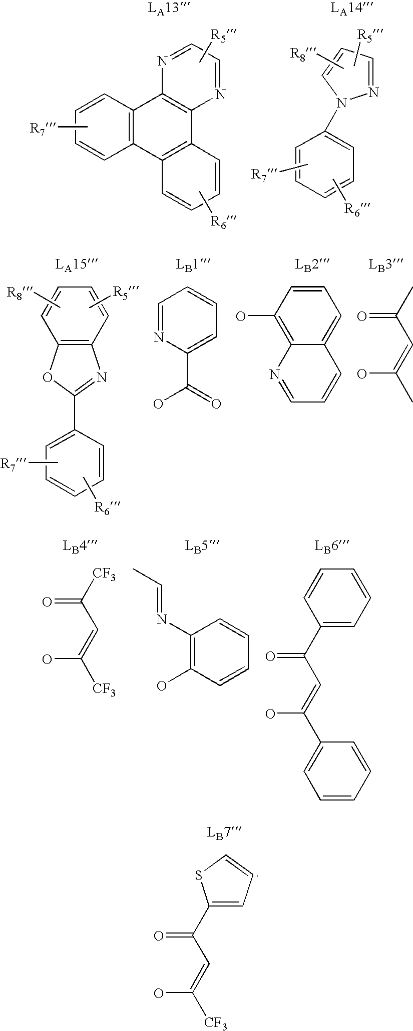

19. The organic electroluminescent device of claim 18, wherein the phosphorescent material is ranged from 0.5 wt % to 20 wt % of the hole-transporting light-emitting layer.
